(19) United States
(12) Patent Application Publication
(10) Pub. No.: US 2005/0027926 A1
(43) Pub. Date: Feb. 3, 2005

(54) Data storage method

(75) Inventors: Eng-Giap Koh, Penang (MY); Chee-Khuan Law, Penang (MY); Yeou-Nee Khor, Penang (MY); Pei-San Lee, Penang (MY); Shih-Hsiung Weng, Taipei (TW)

Correspondence Address: Mr. Peter F. Corless, EDWARDS & ANGELL, LLP, 101 Federal Street, Boston, MA, 02110, US

(73) Assignee: Inventec Multimedia & Telecom Corporation

(21) Appl. No.: 10/630,553

(22) Filed: Jul. 29, 2003

(51) Int. Cl. G06F 12/00

(52) U.S. Cl. 711/100

(57) ABSTRACT

A data storage method is provided, which is applicable to a computer device having a RTC (real-time clock) unit and a memory card access unit. The method includes the steps of: (1) accessing the RTC unit for obtaining a time value of a particular date when the computer device receives a data storage request from the memory card access unit; (2) determining if a memory unit of the computer device performs data storage operation on the particular date; if no, setting an identification value to be 1 and going to step (4); if yes, obtaining an identification value of the latest processed folder of the particular date and going to step (3); (3) adding 1 to the identification value; and (4) using the time value obtained from the RTC unit and the identification value from step (2) as a folder name for data from the memory card access unit.

### FIELD OF THE INVENTION

The present invention relates to data storage methods, and more particularly, to a data storage method which stores data by the name of instant time when the data are stored.

### BACKGROUND OF THE INVENTION

Generally, image data recorded by a digital camera are stored in a memory card such as CompactFlash (CF) card and named by corresponding serial numbers.

However, in the case of a memory card having capacity at the level of MB (megabyte) or GB (gigabyte) used in a multimedia product, an enormous amount of data can be stored in such a memory card, making a user not able to easily differentiate the stored data simply based on their serial numbers. Consequently, more time and effort are required by the user to search and obtain data of interest, which undesirably reduces the speed and efficiency of data search.

Therefore, the problem to be solved herein is to provide a data storage method for use in a multimedia product to allow more efficient data search and storage.

### SUMMARY OF THE INVENTION

In light of the foregoing prior-art drawback, a primary objective of the present invention is to provide a data storage method for use in a computer device so as to allow a user to easily and efficiently search and obtain required data from stored data files.

According to the above and other objectives, the present invention proposes a data storage method which is applicable to a computer device having a real-time clock (RTC) unit. The computer device is connected with a memory card access unit. The data storage method comprises the steps of: (1) determining if a memory unit of the computer device has enough capacity for data storage when the computer device receives data and an inputted request for storing the data from the memory card access unit; if no, prompting an error message to a user and terminating a data storage process; if yes, proceeding to step (2); (2) reading the RTC unit via the computer device to obtain a time value of a particular date when the data are received; (3) determining if the memory unit of the computer device performs data storage operation on the particular date; if no, setting an identification value to be 1, and proceeding to step (5); if yes, obtaining an identification value of the latest processed folder on the particular date, and proceeding to step (4); (4) adding 1 to the obtained identification value via the computer device; and (5) using the time value from the RTC unit and the identification value from the step (3) as a folder name for the data from the memory card access unit, and completely storing the data in the memory unit via the computer device.

Besides, the computer device can also use the time value from the RTC unit and the identification value from the step (3) as a name for a data file to be stored in the computer device.

Therefore, the above data storage method utilizes the RTC unit of the computer device to perform data storage. During the data storage, the computer device obtains and adds a time signal from the RTC unit with a number of times of data storage on the particular date as a file name for the stored data. Consequently, the data storage method, which uses the data storage time as the file name, allows the user to more easily search and access data as compared to the prior art using serial numbers for naming the stored data, thereby saving the time and effort of the user on data search.

### BRIEF DESCRIPTION OF THE DRAWINGS

The present invention can be more fully understood by reading the following detailed description of the preferred embodiments, with reference made to the accompanying drawings, wherein:

FIG. 1 is a block schematic diagram showing a basic hardware structure for use with a data storage method according to the invention;

FIG. 2 is a flow chart showing a series of procedural steps of the data storage method according to the invention; and

FIG. 3 is a block schematic diagram showing another basic hardware structure for use with the data storage method according to the invention.

### DETAILED DESCRIPTION OF THE PREFERRED EMBODIMENTS

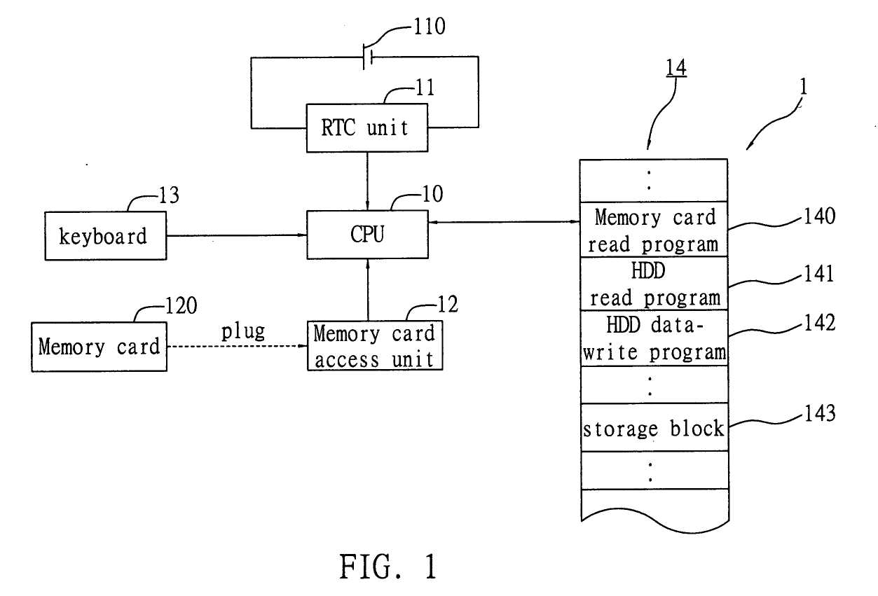

A basic hardware structure for use with a data storage method proposed by the present invention is shown in FIG. 1, wherein the data storage method is applicable to a common computer device 1, such as notebook computer, desktop personal computer (PC), digital camera, mobile phone, multimedia player, personal digital assistant (PDA), etc. The computer device 1 comprises a central processing unit (CPU) 10, a RTC unit 11, a memory card access unit 12, a keyboard 13, and a memory unit 14. It should be noted that, for the sake of simplicity, the drawing only illustrates relevant components of the basic structure to the proposed data storage method; in other words, irrelevant components such as display screen are omitted here.

The RTC unit 11 is a clock unit on a computer motherboard (not shown) having a battery 110 for continuously supplying power to the RTC unit 11. When the computer device 1 is started up, a basic input/output system (BIOS, not shown) on the computer motherboard reads time shown on the RTC unit 11 and continues the clock operation without interruption. Following the completion of BIOS testing, a computer operating system e.g. Windows is actuated. Since the RTC unit 11 is a conventional component well known in the art, no further description to the function and structure thereof is provided.

The memory card access unit 12 is connected to the CPU 10 and for accessing data from a memory card 120 inserted into the memory card access unit 12. The memory card 120 can be a CF card used in a digital camera (not shown), or a PCMCIA (Personal Computer Memory Card International Association) card, secure digital (SD) card, memory stick (MS) card or smart media card (SMC), depending on the memory card access unit 12.

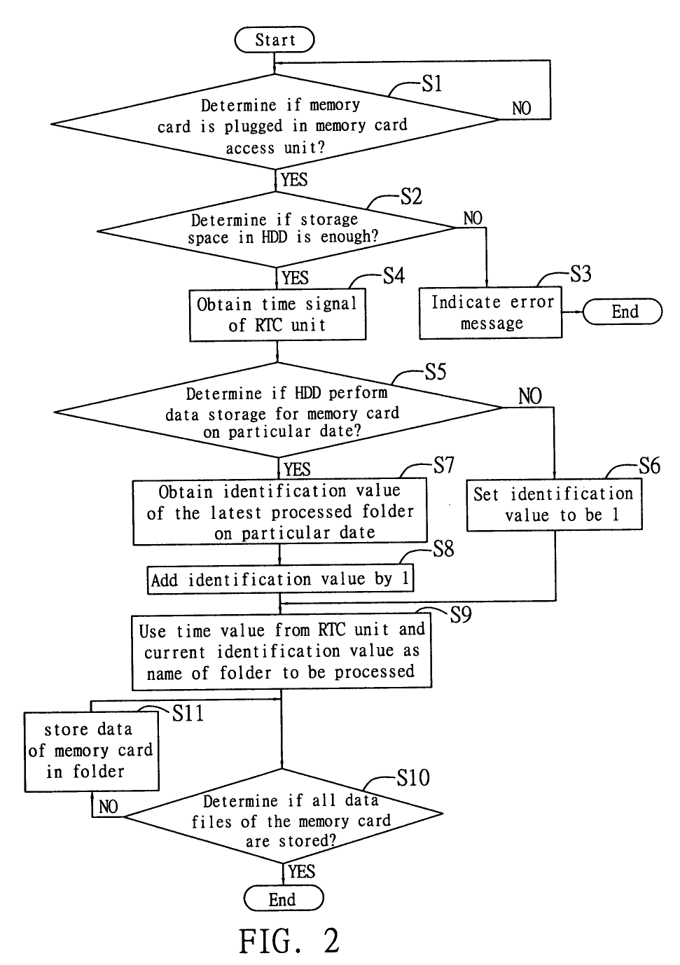

The memory unit 14 is connected to the CPU 10 and for storing data required for operation of the CPU 10 or to be accessed by a user. In this embodiment, the memory unit 14 is a computer hard disk (HDD), which at least stores a memory card read program 140, a HDD read program 141, and a HDD data-write program 142, and has a storage block 143 for storing data from the memory card 120. The aforementioned memory card read program 140, HDD read program 141, HDD data-write program 142 and storage block 143 are specified hereinafter with reference to FIG. 2 for the data storage method according to the invention to allow the user who operates the computer device 1 to perform the data storage operation.

FIG. 2 shows a series of procedural steps of the data storage method according to the invention, which enables data from the memory card 120 to be stored in the computer device 1 by using a date of storing data as a data folder name, such that the user can easily search and browse data from the computer device 1. As shown, when the user inputs a request for storing data to the memory card 120 via a keyboard 13 of the computer device 1, the data storage process goes to step S1 in which it is to determine if the memory card 120 is plugged in the memory card access unit 12. If yes, the process goes to step S2; or otherwise, the process returns to step S1.

In step S2, the computer device 1 determines if the storage block 143 of the memory unit 14 (i.e. HDD) provides enough data storage space; if not, the process goes to step S3; or otherwise, the process goes to step S4.

In step S3, the computer device 1 actuates a display unit (not shown) thereof to show an error message which informs the user of failure in performing the data storage operation, and thus the data storage process is terminated.

In step S4, the computer device 1 reads a time signal from the RTC unit 11, and then the process goes to step S5.

In step S5, the computer device 1 determines if the storage block 143 of the memory unit 14 contains a data folder created on a particular date when performing data storage for the memory card 120; if yes, the process goes to step S7; if no, the process goes to step S6.

In step S6, the computer device 1 establishes and sets an identification value to be 1, and then the process goes to step S9.

In step S7, the computer device 1 obtains an identification value corresponding to the folder created on the particular date from the storage block 143, and then the process goes to step S8.

In step S8, the computer device 1 adds 1 to the identification value, and then the process goes to step S9.

In step S9, the computer device 1 uses a time value of the time signal from the RTC unit 11 and the identification value as a name for a data folder which is currently to be processed. Then, the process goes to step S10.

In step S10, the computer device 1 determines if all data files in the memory card 120 that is coupled to the memory card access unit 12 are completely stored; if yes, the data storage process is ended; or otherwise, the process goes to step S11.

In step S11, the computer device 1 stores data files in the memory card 120, which are not yet stored, to the current folder, and then the process returns to step S10.

In particular, when the CPU 10 receives a data storage request in association with the memory card 120 from the user through the keyboard 13, the CPU 10 executes the memory card read program 140 to determine if the memory card 120 is properly plugged in the memory card access unit 12, i.e. step S1 shown in FIG. 2. Then, the CPU 10 executes the HDD read program 141 to determine if the storage block 143 of the memory unit 14 provides enough space for storing data from the memory card 120, i.e. steps S2 and S3 of FIG. 2. Subsequently, the CPU 10 executes the HDD data-write program 142 to store data from the memory card 120 to the storage block 143 of the memory unit 14, i.e. steps S4 to S11 of FIG. 2. For instance, if the user carries out the data storage process for four memory cards 120 on the same date e.g. Oct. 17, 2002, the computer device 1 is urged to create four folders in the storage block 143 of the memory unit 14 and name the four folders as follows:
20021017.001,
20021017.002,
20021017.003, and
20021017.004.

In the event of the user performing the data storage process for two memory cards 120 today which is assumed to be Oct. 17, 2002, for another memory card 120 on tomorrow, and for a further memory card 120 on the day after tomorrow, the computer device 1 is urged to create four folders in the storage block 143 of the memory unit 14 and name the four folders as follows:
20021017.001,
20021017.002,
20021018.001, and
20021019.001.

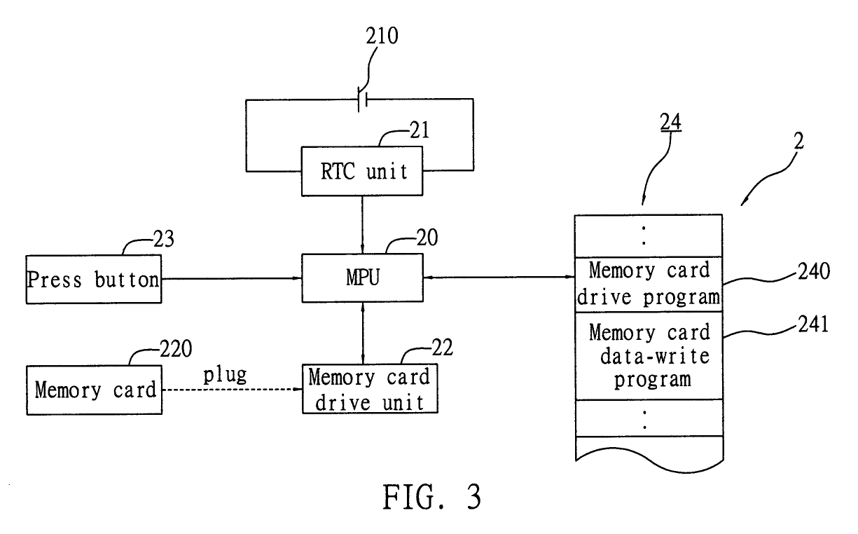

FIG. 3 shows another basic hardware structure for use with the data storage method according to the invention, which is applicable to a digital camera 2 comprising a micro processing unit (MPU) 20, a RTC unit 21, a memory card drive unit 22, at least one press button 23, and a memory unit 24.

The memory unit 24 can be a read-only memory (ROM) or electrically erasable programmable read-only memory (EEPROM), for storing a memory card drive program 240 and a memory card data-write program 241. The memory card drive program 240 and memory card data-write program 241 are specifically constructed for use in the data storage method according to this embodiment whose procedural steps are primarily the same as those shown in FIG. 2, with the only difference in that the digital camera 2 of this embodiment can directly create folders for data to be stored in a memory card 220, and the folders are named by the time or date of data storage.

In conclusion, the data storage method according to the invention names a data folder or file by the time or date of data storage, which allows a user to easily and conveniently manage and search data files. Compared to the prior art using serial numbers for naming stored data files, by which different memory cards may even contain data files of the same serial number, and the user is difficult to manage and maintain the data files, therefore, the data storage method according to the invention possesses more preferable improvement and practicability than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A data storage method, which is applicable to a computer device having a RTC (real-time clock) unit, comprising the steps of:
(1) determining if a memory unit of the computer device has enough capacity for data storage when the computer device receives data and an inputted request for storing the data; if no, prompting an error message to a user and terminating a data storage process; if yes, proceeding to step (2);
(2) reading the RTC unit via the computer device to obtain a time value of a particular date when the data are received;
(3) determining if the memory unit of the computer device performs data storage operation on the particular date; if no, setting an identification value to be 1, and proceeding to step (5); if yes, obtaining an identification value of the latest processed data folder on the particular date, and proceeding to step (4);
(4) adding the obtained identification value by 1 via the computer device; and
(5) using the time value from the RTC unit and the identification value from the step (3) as a name for a folder to be created, and completely storing the data in the memory unit via the computer device.

2. The data storage method of claim 1, wherein the computer device is selected from the group consisting of a desktop personal computer (PC), notebook computer, digital camera, digital voice/video recorder, mobile phone, multimedia player, and personal digital assistant (PDA).

3. The data storage method of claim 1, wherein the memory unit is a hard disk (HDD) or memory card.

4. The data storage method of claim 1, wherein the data received by the computer device are from a HDD or memory card.

5. The data storage method of claim 1, wherein in the step (5), the time value from the RTC unit and the identification value from the step (3) are used as a name for a created folder, allowing the data to be stored in this folder.

6. The data storage method of claim 3, wherein the memory card is selected from the group consisting of a CF (CompactFlash) card, PCMCIA (Personal Computer Memory Card International Association) card, SD (secure digital) card, MS (memory stick) card, and SMC (smart media card).

7. The data storage method of claim 4, wherein the memory card is selected from the group consisting of a CF card, PCMCIA card, SD card, MS card, and SMC.

8. The data storage method of claim 1, wherein in the step (5), the time value from the RTC unit and the identification value from the step (3) are used as a name for a data file to be stored in the computer device.
